(19) United States
(12) Patent Application Publication
(10) Pub. No.: US 2002/0071983 A1
(43) Pub. Date: Jun. 13, 2002

(54) Flow field plates

(76) Inventors: Stuart James Rowen, London (GB); Mark Christopher Turpin, Loughborough (GB); Paul Leonard Adcock, Loughborough (GB); Damian Davies, Newark (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/875,685

(22) Filed: Jun. 6, 2001

Related U.S. Application Data
(63) Continuation of application No. PCT/GB00/02591, filed on Jul. 4, 2000.

(30) Foreign Application Priority Data
Jul. 8, 1999 (GB) 9915925.3

(51) Int. Cl. H01M 8/02

(52) U.S. Cl. 429/34; 216/18

(57) ABSTRACT

The present invention relates to flow field plates and the manufacture thereof, for use in fuel cells. The method of manufacture comprises particulate etching of a plate material using a particulate etchant (eg. sand blasting), a particulate etchant accelerator and a particulate etchant-resistant patterned mask, such that a fluid flow pattern determined by the pattern design on said mask is formed on the plate material.

This invention relates to flow field plates and the manufacture thereof, for use in fuel cells, electrolysers, and batteries which contain a fluid electrolyte.

A fuel cell is an electrochemical device in which chemical energy is converted directly into electrical energy. Fuel cells employ electrodes, comprising an anode and a cathode, electrocatalysts, often supported on the electrodes, and an electrolyte. A fuel and an oxidant are separately supplied to the anode and cathode, respectively.

Solid Polymer Fuel cells (SPFC) employ a membrane electrode assembly (MEA), consisting of a solid polymer electrolyte with impressed electrocatalyst layers sandwiched between two electrically conductive plates which have a fluid flow field to distribute the fuel and oxidant across the active area of the electrodes. These flow field plates, also known as current collector plates or bipolar plates, may additionally provide mechanical support for the MEA. Fluid galleries are formed in the faces of the flow field plates to direct fuel and oxidant, respectively, into the fluid flow field. Fluid exit galleries in the flow field plates allow for removal of unreacted fuel and oxidant as well as reaction product (e.g. water in an oxygen/hydrogen fuel cell) formed at the cathode.

Performance of fuel cells is partly dependent on the efficient supply of fuel and oxidant to the electrodes and also the efficient removal of reaction product during functioning of the cell. The design and manufacture of flow fields on flow field plates is thus an important consideration for optimal fuel cell operation.

For most applications, fuel cells may be connected in series to form a “stack” so that voltage output is increased. The flow field plates between cells may be bipolar such that fuel and oxidant are distributed separately through flow fields on opposite faces of the plate. In stacks, flow field plates should be impermeable to reactants to prevent crossover between adjacent cells.

Flow field plates used in fuel cell stacks have been constructed from several types of material. This material requires the following properties:

(i) chemical compatibility with electrolytes;

(ii) low resistivity (contact and bulk) to reduce power loss;

(iii) impermeability to H₂ and O₂;

(iv) allows for easy manufacture of plates;

(v) light in weight; and

(vi) sufficient strength to withstand handling and high compaction pressures.

Carbon-based flow field plates have been reported for use in low temperature fuel cells, particularly SPFCs. Carbon is an excellent material for this application, possessing excellent chemical resistance, low density and high electronic and thermal conductivity.

Press-moulding has been used to fabricate a flow field plate, complete with embossed fluid flow design thereon, from exfoliated graphite. For example, a flow field plate manufactured from a fine grained graphite (GRAFOIL®) is provided in U.S. Pat. No. 5,521,018.

U.S. Pat. No. 4,301,222 and EP 784 352 describe the use of resins to form plates with improved mechanical strength, but these insulating resins may reduce the overall conductivity of such plates and result in increased losses in fuel cell stacks. In another invention, U.S. Pat. No. 4,339,322, carbon fibres have been added to a polymer/graphite material to enhance plate strength and conductivity. However, resistivities of the plates disclosed in U.S. Pat. No. 4,339,322 are significantly higher than plate manufactured only from graphite.

As described in U.S. Pat. No. 5,686,199, it is possible to machine fine grained graphite plates to form fluid flow patterns. Due to low mechanical strength of the material, however, these plates are often unacceptably thick. Also, the machining of fluid flow fields on carbon plates is a slow process and tool wear is rapid with this material. Carbon fibre composite materials are even more abrasive and more damaging to cutting tools than standard carbon material. These materials have been avoided due to the costly specialized equipment employed.

Current technology therefore does not provide a rapid, low cost process for the manufacture of flow field plates from desirable materials.

The technique of sand, bead, or grit blasting has been described previously for a few specified applications, such as signmaking and decorative patterning on stone, wood, ceramicware, plastic, glass and glass-reinforced plastic (e.g. U.S. Pat. No. 4,828,893 and U.S. Pat. No. 4,985,101), and surface cleaning or roughening treatments. Sandblasting has also been employed for forming plasma display apparatus (EP 0 722 179) and in the manufacture of magnetic transducing heads (U.S. Pat. No. 4,188,247).

The present invention provides a novel, effective and improved method for the manufacture of electrochemical cell components such as the flow field plate. The method employs a low cost and rapid erosive etch that allows formation of fluid flow patterns, fluid entry galleries and fluid exit galleries, and sealing grooves.

Thus according to the present invention, there is provided a method for the manufacture of flow field plates comprising particulate etching of plate material using a particulate etchant, a particulate etchant accelerator and a particulate etchant-resistant patterned mask, such that a fluid flow pattern determined by the pattern design on said mask is formed on said plate material.

Plate material for use in the present invention may comprise electrically conductive material. Such electrically conductive material may comprise carbon-based material. Furthermore, plate material may comprise carbon fibre composite material. This carbon fibre composite material may be densified with a polymeric filler, for example an epoxy resin. It has been found, surprisingly, that the rate of particluate etching of the carbon fibre and matrix in carbon fibre composite material does not differ, so the final structure of patterned grooves formed in this type of materials is not adversely affected.

The particulate etching may comprise sand blasting, and the particulate etchant accelerator may comprise a sandblasting gun. The particulate etching may also comprise grit blasting. Furthermore, the particulate etching may comprise abrasive waterjet blasting (also known as abrasive waterjet cutting). The invention requires that the particulate etchant contains an abrasive medium which has a greater hardness than that of the plate material to be etched. The particulate etchant may be silica grit with a diameter of 180-220 μm for use against plate material which is a graphitised carbon-carbon composite material.

The procedure uses a particulate etchant-resistant mask which is patterned accordingly and which covers the face of the material to be etched. The mask may be composed of material that can withstand erosive wear caused by particulate etching. The mask should be in close proximity to the plate material to allow fine detailed patterns to be formed, so the mask may be held in contact with the plate material by means of an adhesive substance.

The particulate etchant-resistant patterned mask may be a photoresist mask. The technique of forming a photoresist mask is taught in, for example, U.S. Pat. No. 4,764,449. In U.S. Pat. No. 4,764,499, a negative mask of the required design is formed such that glass or wood exposed after adhesion of the mask is eroded by sandblasting.

The particulate etchant-resistant patterned mask may comprise a vinyl polymer. Here, a vinyl label is cut to shape to form a negative mask of the required pattern (see U.S. Pat. No. 4,828,893).

The pattern design may determine a fluid entry gallery and a fluid exit gallery of the field flow plate. For example, a fluid entry gallery may be a fluid entry hole and a fluid exit gallery may be a fluid exit hole of the flow field plate. Certain etch resists could fail if galleries passing through the plate are etched through one face only. Therefore fluid entry galleries and fluid exit galleries may be formed by etching aligned positions on opposite faces of the flow field plate.

The pattern design may also determine grooves for seals on said flow field plate.

Particulate etching may be under the control of a two-axis scanning mechanism that determines movement of the particulate etchant accelerator relative to the plate material. The two-axis scanning mechanism may enable a predetermined movement of the plate material relative to the particulate etchant accelerator such movement can be in the form of a raster pattern or a stepped scan pattern. A scanning mechanism will be particularly useful when the surface area of the plate material is approaching or greater than the spread of particulate from the particulate etchant accelerator.

Flow field plate manufactured according to the present invention may be incorporated in fuel cells, electrolysers- and batteries which contain a fluid electrolyte. An electrolyser, which is a means to decompose water into hydrogen and oxygen, is structurally very similar to a fuel cell.

The invention will be further apparent from the following description, with reference to the several figures of the accompanying drawings, which show, by way of example only, methods for the manufacture of field flow plates comprising different materials.

Of the Figures:

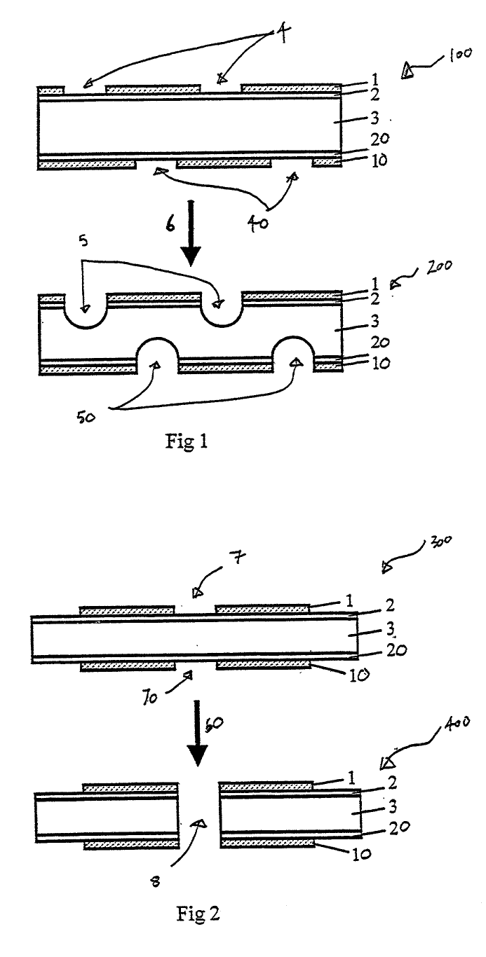

FIG. 1 is a schematic side cross-sectional elevation illustrating the particulate etching method employed in the fabrication of fluid flow grooves on a bipolar flow field plate; and

FIG. 2 is a schematic side cross-sectional elevation illustrating the particulate etching method employed in the fabrication of a fluid entry or exit hole in a flow field plate.

In FIG. 1, a flow field plate 100 prepared for particulate etching comprises the plate material 3, and two opposite faces each layered with an adhesive 2 and 20 upon which the prepared particular enchant-resistant patterned masks 1 and 10 have been attached. The adhesive 2 and 20 must provide sufficient adhesion to hold the masks 1 and 10 firmly in place during the particulate etching process 6. Preferably, the adhesive 2 and 20 is water soluble so that the masks 1 and 10 can be easily removed from the plate material 3 after etching. The masks 1 and 10 may be mounted on a support film which is peeled away after the masks 1 and 10 have adhered to the adhesive 2 and 20.

Plate material 3 comprises carbon fibre composites, thereby possessing superior mechanical properties to monoliths, without loss of mechanical properties. The inclusion of carbon fibres can improve the thermal conductivity of plate material 3, which is an important feature if the downstream electrical application involves use of high current densities. Fabrication methods for typical carbon-carbon composite material are well known (See Thomas, C. R. [Editor], 1993, Essentials of carbon-carbon composites, Cambridge Royal Society of Chemistry Press, Cambridge, ISBN: 0851868045).

Use of high density carbon-carbon composites for plate material 3 is expensive, and partially densified materials may offer greater prospects. The gas permeability of partially densified plate material can be overcome by densification with a polymeric filler such as resin. The resin should preferably be of low viscosity to allow the rapid filling of small pores under low pressure, and should self-cure. The composition of the resin may be of any polymer formulation that will resist attack by an alkaline or acidic electrolyte. Immediately after the addition of a resin to plate material 3, unabsorbed resin should be removed from the surface of the plate 100. This can be carried out by wiping the plate 100 surface with an absorbent cloth. When the resin has been allowed to cure under the required conditions, surfaces on plate 100 required for electrical conduction need to be cleaned to re-expose conductive carbon in plate material 3 . This can be achieved by a brief surface grinding step with an abrasive cloth with a mesh size of 600 or higher.

The particulate etchant-resistant patterned masks 1 and 10 have patterns 4 and 40 through which the plate material 3 will be etched. Pattern 4 on one face of plate material 3 is displaced relative to pattern 40 on the second face of plate material 3 so that a thin sheet of plate material 3 can be employed. Etching process 6 involves the exposure of the plate 100 to a particulate etchant (not shown) which is propelled by a particulate etchant accelerator (not shown) such as a sandblasting gun. The particulate etchant is any material which has a greater hardness than that of the plate material 3 to be etched. For carbonaceous materials (except diamonds), it is preferred that fine grained silica or alumina is used. The etchant size depends on the detail of the patterns 4 and 40 required on the plate 100.

The blasting pressure used in process 6 is dependent on masks 1 and 10, the adhesive 2 and 20, the distance between the etchant accelerator and the target surface of the plate material 3, and the etchant used. An upper pressure limit is given by the resistance to erosive etching of the masks 1 and 10, while a lower limit is defined by the pressure required to erode the material 3 with the abrasive etchant. The blasting pressure is optimal when substantial etching is produced within a reasonable time limit without damaging the masks 1 and 10 or causing the adhesive 2 and 20 to fail.

Etching process 6 is performed in two successive steps in which each face of plate 100 is etched. It is not ruled out, however, that the etching process 6 could be performed on both sides of plate 100 simultaneously using a plurality of particulate etchant accelerators.

During etching process 6, the target area of plate 100 is dependent on the spread of the etchant. This spread, in turn, is dependent on the distance of the particulate etchant accelerator from the surface of plate 100, and the dimensions of the particulate etchant accelerator nozzle (not shown). The plate 100 can be etched in a dynamic manner if the area of plate 100 is larger than the etchant spread. For example, the particulate etchant accelerator and plate 100 can be moved relative to each other using a two-axis scanning mechanism, in which either or both the accelerator and plate 100 are moved. The overall movement should provide uniform coverage of the plate 100 surface with the accelerated etchant.

After completion of etching process 6, the flow field plate 200 has a fluid flow field pattern 5 and 50 etched into the plate material 3 on both sides of the plate 200. The adhesive 2 and 20 and particulate etchant-resistant patterned mask 1 and 10 are then removed.

The fabrication of flow field plate holes for the entry or exit of fluids is illustrated in FIG. 2. Preparation of flow field plate 300 requires the alignment of eroding grooves 7 and 70 patterned into the particulate etchant-resistant masks 1 and 10 on opposite faces of the plate material 3. The masks 1 and 10 are held firmly against the plate material 3 using an adhesive 2 and 20. Etching process 60 proceeds until a uniform opening 8 appears from one face of plate 400 through to the opposite face. Etching of both faces of plate material 3 to form the opening 8 is especially important where the material 3 would fail if etched from one face only.

The present invention will be further described by way of the following examples. The scope of the invention, however, is not limited in any way by these examples.

### EXAMPLE 1

### Carbon-carbon Composite Plate+Vinyl Mask

A graphitised carbon-carbon composite plate of dimensions 50×50×1.2 mm was prepared with a gas track design on one face. A vinyl-polymer adhesive mask (FasCal Film [Avery, US]), with a negative image of the required gas track design, was pressed firmly onto the composite. A Guyson Blast System (Guyson, UK) with 180-220 μm silica grit, was used to dry sandblasting the plate. The masked material was held under the sandblasting gun with a blast pressure set at 4 bar (400 kPa) for 30s, at a constant distance of 6″ (152.4 mm). The vinyl mask was then peeled off, and the adhesive washed off the plate using isopropyl alcohol. Track depth was 0.2-0.25 mm.

### EXAMPLE 2

### Carbon-carbon Composite Plate+Photoresist Mask

A graphitised carbon-carbon composite plate of dimensions 50×50×1.2 mm was prepared with a gas track design on one face. A photoresist mask (ImagePro Super Film [Chromaline Corp., US]) was developed to form a negative template of the required gas track design. Using a photographic mask of the track design to cover the photoresist (with an underside protective carrier film) and a glass sheet to hold the sheets closely together, the film was exposed for 5 minutes to an 18 W UV light source, at a distance of 5 m. The film was then removed (under yellow light) and washed under running water for approximately 3 minutes in order to wash away unexposed resist. The resist film was dried in air, under normal lighting, to form the negative resist mask template. A liquid contact adhesive (ImagePro Adhesive [Chromaline Corp., US]) was brushed lightly over the composite plate surface, and allowed to dry in air for 10 minutes. The resist mask (with carrier film) was pressed onto the adhesive-covered plate, and the carrier film peeled away. The material was then blasted using the procedure described in Example 1 (supra). The resist mask was removed by dissolving the adhesive using warm running water, thus revealing a flow field pattern etched into the carbon-carbon composite material.

### EXAMPLE 3

### Carbon-carbon Composite Plate With Epoxy Resin+Photoresist Mask

A graphitised carbon-carbon composite plate of dimensions 50×50×1.2 mm was held under low pressure (preferably less than 10 mmHg [approximately 1.33 kPa], but up to 100 mmHg [approximately 13.3 kPa] feasible) impregnated with a low viscosity epoxy resin (SpeciFix-20 [Struers Ltd, UK]). Excess resin was removed from the surface of the plate using a paper towel. The plate was then allowed to stand in air, at standard temperature and pressure, for at least 8 hours to allow the resin to cure and harden. A photoresist mask (ImagePro Super Film) was prepared and then applied as in Example 2 (supra). The masked material was then blasted using the procedure described in Example 1 (supra). The resist mask was removed by dissolving the adhesive using warm running water.

1. A method of manufacturing a flow field plate comprising:
a. positioning a particulate etchant-resistant mask comprising a pattern design adjacent a plate; and
b. particulate etching the plate using a particulate etchant and a particulate etchant accelerator so that a fluid flow pattern determined by the pattern design is formed on the plate.

2. The method of claim 1, wherein the plate comprises electrically conductive material.

3. The method of claim 1, wherein the plate comprises carbon-based material.

4. The method of claim 3, wherein the plate comprises carbon fibre composite material.

5. The method of claim 4, wherein the carbon fibre composite material is densified with a polymeric filler.

6. The method of claim 1, wherein the particulate etching comprises sand blasting.

7. The method of claim 1, wherein the particulate etching comprises bead blasting.

8. The method of claim 1, wherein the particulate etching comprises grit blasting.

9. The method of claim 1, wherein the particulate etching comprises abrasive water jet blasting.

10. The method of claim 6, wherein the particulate etchant accelerator comprises a sandblasting gun.

11. The method of claim 1, wherein the particulate etchant contains an abrasive medium which is harder than the plate.

12. The method of claim 11, wherein the particulate etchant comprises silica grit having a diameter of 180-220 μm.

13. The method of claim 12, wherein the plate comprises a graphitised carbon-carbon composite material.

14. The method of claim 1, wherein positioning the particulate etchant-resistant mask adjacent the plate comprises adhering the mask to the plate with an adhesive substance.

15. The method of claim 1, wherein the particulate etchant-resistant patterned mask is a photoresist mask.

16. The method of claim 1, wherein the particulate etchant-resistant patterned mask comprises a vinyl polymer.

17. The method of claim 1, wherein the pattern design determines a fluid flow pattern having a fluid entry gallery and a fluid exit gallery on the flow field plate.

18. The method of claim 17, wherein the fluid entry gallery and the fluid exit gallery are formed by etching aligned positions on opposite faces of the flow field plate such that the fluid entry gallery and the fluid exit gallery pass through the flow field plate.

19. The method of claim 1, wherein the pattern design determines a sealing groove on the flow field plate.

20. The method of claim 1, wherein particulate etching comprises using a two-axis scanning mechanism to determine the movement of the particulate etchant accelerator relative to the plate.

21. The method of claim 20, wherein the two-axis scanning mechanism enables a predetermined movement of the plate relative to the particulate etchant accelerator such that the movement is in the form of a raster pattern or a stepped scan pattern.

22. A flow field plate formed by:
a. positioning a particulate etchant-resistant mask comprising a pattern design adjacent the plate; and
b. particulate etching the plate using a particulate etchant and a particulate etchant accelerator so that a fluid flow pattern determined by the pattern design is formed on the plate.
